(19) United States
(12) Patent Application Publication
(10) Pub. No.: US 2001/0012572 A1
(43) Pub. Date: Aug. 9, 2001

(54) Novel polymer, light-emitting device material and light-emitting device using the same

(76) Inventor: Katsumi Araki, Kanagawa (JP)

Correspondence Address: SUGHRUE, MION, ZINN, MACPEAK & SEAS, PLLC, 2100 Pennsylvania Avenue, N.W., Washington, DC, 20037, US

(21) Appl. No.: 09/732,709

(22) Filed: Dec. 11, 2000

(30) Foreign Application Priority Data
Dec. 10, 1999 (JP) P. HEI.11-351841
Jan. 18, 2000 (JP) P. 2000-9210
Feb. 17, 2000 (JP) P. 2000-39703

(51) Int. Cl. H05B 33/14; C08G 10/00; C08G 61/12

(52) U.S. Cl. 428/690; 526/258; 428/704; 428/917; 313/504; 313/506; 257/40; 257/103; 252/301.35; 526/265; 526/315; 526/294; 528/247; 528/248

(57) ABSTRACT

Disclosed are a novel polymer comprising at least one partial structure represented by the following formula (I), (II) or (III), a light-emitting device material which is the polymer, and a light-emitting device using the material:

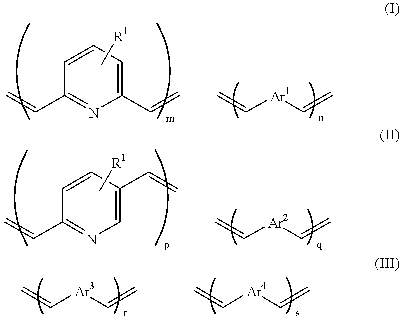

wherein Ar¹ represents a conjugate unsaturated group exclusive of a nitrogen-containing heterocyclic ring having 2 or more nitrogen atoms, m and n each represents a partial ratio by mol in the polymer and satisfies the condition that m+n=100 where n is a numerical value of 0 to less than 100, R¹ represents hydrogen atom or a substituent, provided that when Ar¹ is a substituted fluorene ring or an alkoxy-substituted benzene ring, n is not a value of 50, Ar² represents a conjugate unsaturated group exclusive of a conjugate unsaturated group comprising a benzene ring substituted at two or more positions by an alkyl group having 12 or more carbon atoms, an alkoxy group having 16 or more carbon atoms, an alkoxycarbonyl group having 12 or more carbon atoms or an acyloxy group having 12 or more carbon atoms, and a conjugate unsaturated group comprising a nitrogen-containing heterocyclic ring having a 2,6-pyridinediyl group and 2 or more nitrogen atoms, p and q each represents an arbitrary partial ratio by mol in the polymer but is not a numerical value of 0 or 100, R² represents hydrogen atom or a substituent, Ar³ represents a heteroarylene group having 2 or more nitrogen atoms, Ar⁴ represents a conjugate unsaturated group, and r and s each represents a molar percentage in the polymer and satisfies the condition that r+s=100 where s is a numerical value of 0 to less than 100, provided that when Ar³ is a 2,2′-dipyridyl-4,4′-diyl group or a 2,5-pyrazinediyl group, s is not a value of 0 or 50.

### FIELD OF THE INVENTION

The present invention relates to a polymer having a high electron affinity and also relates to a light-emitting device material and a light-emitting device which can convert electric energy into light to emit light, more specifically, the present invention relates to a light-emitting device which can be suitably used in the field of display device, display, backlight, electrophotography, illumination light source, recording light source, reading light source, marking, billboard, interior decoration and the like.

### BACKGROUND OF THE INVENTION

At the present time, development of and studies on various display devices are aggressively proceeding. In particular, organic light-emitting devices can provide highly bright luminescence at a low voltage, therefore, are drawing an attention as a promising display device. For example, a light-emitting device comprising an organic thin film formed by depositing an organic compound is known (see, Applied Physics Letters, Vol. 51, page 913 (1987)). However, the manufacture of a light-emitting device involving an operation of depositing an organic compound has a problem in the productivity and from the standpoint of simplification of the production process, workability and formation of a large surface area, the device is preferably manufactured by a coating method.

With respect to the light-emitting device material for use in the manufacture of a light-emitting device by a coating method which is advantageous in view of productivity, for example, a π-conjugate polymer represented by polyparaphenylene vinylene (PPV) is known, however, for the use in practice, this polymer has many problems in the tone, luminescence intensity, durability and the like.

With respect to the light-emitting device manufactured using a coating method, for example, a device comprising poly(N-vinylcarbazole) having dispersed therein a low molecular weight fluorescent compound is known (see, JP-A-4-212286 (the term “JP-A” as used herein means an “unexamined published Japanese patent application”). According to this system, the kind of the fluorescent compound can be freely changed, therefore, the tone and luminescence intensity may be relatively easily controlled, however, the driving voltage is high and the durability has a problem, for example, in the case of driving after a long-term aging or in the case of continuous driving, the brightness is liable to decrease.

As one of the causes for these problems, poorness in the electron-injecting property from the cathode or in the electron-transporting property is considered responsible therefor and in this respect, various attempts have been made to develop an electron-injecting and electron-transporting polymer. However, the polymers still cannot satisfy the physical properties and capability. For example, polyacetylene and the like well known as an electron-transporting (electrically conducting) polymer have a problem in the solubility and film-forming property and are not suitable for the manufacture of a device by a coating process. Furthermore, polymers such as poly(2,5-pyridinediyl) described in J. Phys.: Condens. Matter, 10, 5171-5178 (1998), and poly(p-pyridylvinylene) described in Synthetic Metals, 85, 1179-1182 (1997), cannot be used in the blue light-emitting device and green light-emitting device due to their narrow band gap as an electron-transporting material and moreover, these polymers are deficient in the electron affinity (electron-injecting property), low in the electrical conducting property, sparingly soluble in general-purpose organic solvents and soluble only in specific solvents such as formic acid. Thus, the problems in conventional techniques cannot be solved by these polymers.

### SUMMARY OF THE INVENTION

An object of the present invention is to provide a light-emitting device material having good electron-transporting property, suitable for the manufacture of a light-emitting device by a coating process, capable of low-voltage driving with good luminescence properties, applicable to a wide wavelength region and favored with excellent stability in repeated use.

Another object of the present invention is to provide a light-emitting device using the material.

Still another object of the present invention is to provide a novel conjugate polymer.

The above-described objects can be attained by the following means.

[1] A light-emitting device material which is a polymer comprising at least one partial structure represented by the following formula (I), (II) or (III):

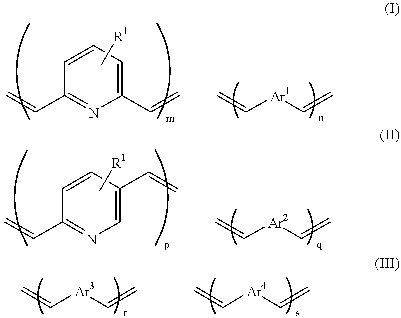

wherein Ar¹ represents a conjugate unsaturated group exclusive of a nitrogen-containing heterocyclic ring having 2 or more nitrogen atoms, m and n each represents a partial ratio by mol in the polymer and satisfies the condition that m+n=100 where n is a numerical value of 0 to less than 100, R¹ represents hydrogen atom or a substituent, provided that when Ar¹ is a substituted fluorene ring or an alkoxy-substituted benzene ring, n is not a value of 50, Ar² represents a conjugate unsaturated group exclusive of a conjugate unsaturated group comprising a benzene ring substituted at two or more positions by an alkyl group having 12 or more carbon atoms, an alkoxy group having 16 or more carbon atoms, an alkoxycarbonyl group having 12 or more carbon atoms or an acyloxy group having 12 or more carbon atoms, and a conjugate unsaturated group comprising a nitrogen-containing heterocyclic ring having a 2,6-pyridinediyl group and 2 or more nitrogen atoms, p and q each represents an arbitrary partial ratio by mol in the polymer but is not a numerical value of 0 or 100, R² represents hydrogen atom or a substituent, Ar³ represents a heteroarylene group having 2 or more nitrogen atoms, Ar⁴ represents a conjugate unsaturated group, and r and s each represents a molar percentage in the polymer and satisfies the condition that r+s=100 where s is a numerical value of 0 to less than 100, provided that when Ar³ is a 2,2′-dipyridyl-4,4′-diyl group or a 2,5-pyrazinediyl group, s is not a value of 0 or 50.

[2] The light-emitting device material as described in [1] above, wherein in formula (I), Ar¹ is a conjugate unsaturated group exclusive of a nitrogen-containing heterocyclic ring having 2 or more nitrogen atoms, a substituted fluorene ring and an alkoxy-substituted benzene ring.

[3] The light-emitting device material as described in [1] above, wherein in formula (II), Ar² is a conjugate unsaturated group exclusive of a conjugate unsaturated group comprising a benzene ring substituted by an alkyl group, an alkoxy group, an alkoxycarbonyl group or an acyloxy group, and a conjugate unsaturated group comprising a nitrogen-containing heterocyclic ring having a 2,6-pyridinediyl group and 2 or more nitrogen atoms.

[4] The light-emitting device material as described in [1] above, which is a polymer comprising at least a partial structure represented by formula (I).

[5] The light-emitting device material as described in [4] above, wherein in formula (I) , n is a numerical value of 0 to 30.

[6] The light-emitting device material as described in [4] above, wherein in formula (I) , n is a numerical value of 0 to 30 and Ar¹ is phenylene, biphenylene, fluorene, anthracene, pyrrole, oxazole, pyridine or quinoline.

[7] The light-emitting device material as described in [1] above, wherein in formula (II), Ar² is phenylene, biphenylene, fluorene, oxazole, 4,6-pyridinediyl, 2,4-pyridinediyl, 2,5-pyridinediyl or carbazole having a total atom number of at most 20.

[8] The light-emitting device material as described in [1] above, wherein in formula (III), Ar³ is quinoxaline or Ar³ is pyrazine under the conditions that 100>r≧60 and 0<s≦40.

[9] A light-emitting device comprising a pair of electrodes having therebetween a light-emitting layer or a plurality of organic compound thin layers containing a light-emitting layer, wherein at least one layer contains at least one polymer described in [13] below.

[10] A light-emitting device comprising a pair of electrodes having therebetween a light-emitting layer or a plurality of organic compound thin layers containing a light-emitting layer, wherein at least one layer is a layer formed by coating at least one polymer described in [13] below.

[11] A light-emitting device comprising a pair of electrodes having therebetween a light-emitting layer or a plurality of organic compound thin layers containing a light-emitting layer, wherein at least one layer contains at least one polymer described in [14] or [15] below.

[12] A light-emitting device comprising a pair of electrodes having therebetween a light-emitting layer or a plurality of organic compound thin layers containing a light-emitting layer, wherein at least one layer is a layer formed by coating at least one polymer described in [14] or [15] below.

[13] A novel polymer comprising at least one partial structure represented by the following formula (I), (II) or (III):

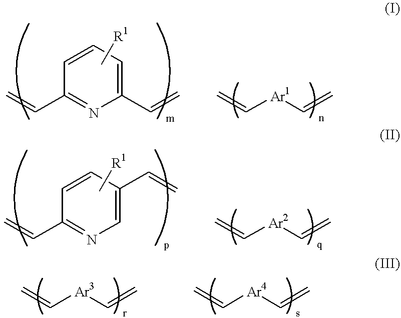

wherein Ar¹ represents a conjugate unsaturated group exclusive of a nitrogen-containing heterocyclic ring having 2 or more nitrogen atoms, m and n each represents a partial ratio by mol in the polymer and satisfies the condition that m+n=100 where n is a numerical value of 0 to less than 100, R¹ represents hydrogen atom or a substituent, provided that when Ar¹ is a substituted fluorene ring or an alkoxy-substituted benzene ring, n is not a value of 50, Ar² represents a conjugate unsaturated group exclusive of a conjugate unsaturated group comprising a benzene ring substituted at two or more positions by an alkyl group having 12 or more carbon atoms, an alkoxy group having 16 or more carbon atoms, an alkoxycarbonyl group having 12 or more carbon atoms or an acyloxy group having 12 or more carbon atoms, and a conjugate unsaturated group comprising a nitrogen-containing heterocyclic ring having a 2,6-pyridinediyl group and 2 or more nitrogen atoms, p and q each represents an arbitrary partial ratio by mol in the polymer but is not a numerical value of 0 or 100, R² represents hydrogen atom or a substituent, Ar³ represents a heteroarylene group having 2 or more nitrogen atoms, Ar⁴ represents a conjugate unsaturated group, and r and s each represents a molar percentage in the polymer and satisfies the condition that r+s=100 where s is a numerical value of 0 to less than 100, provided that when Ar³ is a 2,2′-dipyridyl-4,4′-diyl group or a 2,5-pyrazinediyl group, s is not a value of 0 or 50.

[14] The novel polymer as described in [13] above, wherein in formula (I), Ar¹ is a conjugate unsaturated group exclusive of a nitrogen-containing heterocyclic ring having 2 or more nitrogen atoms, a substituted fluorene ring and an alkoxy-substituted benzene ring.

[15] The novel polymer as described in [13] above, wherein in formula (II), Ar² is a conjugate unsaturated group exclusive of a conjugate unsaturated group comprising a benzene ring substituted by an alkyl group, an alkoxy group, an alkoxycarbonyl group or an acyloxy group, and a conjugate unsaturated group comprising a nitrogen-containing heterocyclic ring having a 2,6-pyridinediyl group and 2 or more nitrogen atoms.

### DETAILED DESCRIPTION OF THE INVENTION

The present invention is described in detail below.

The polymer of the present invention is a compound comprising at least one partial structure represented by formula (I), (II) or (III), preferably having the partial structure represented by formula (I), (II) or (III) on the polymer main chain and/or the side chain.

The polymer having at least a partial structure represented by formula (I), (II) or (III) has high electron affinity and good solubility in water and organic solvents, therefore, this polymer is very effective in the manufacture of a light-emitting device using electron injection, electron transportation and coating processes.

In formula (I), Ar¹ may have a double bond, a triple bond and/or an aromatic ring in the conjugate system thereof and which to select is determined according to various physical properties of the polymer formed. Ar¹ may also have two or more skeletons and the polymer as a whole may be a multiple copolymer. Ar¹ is preferably a substituted or unsubstituted arylene group having a total atom number of at most 20, a substituted or unsubstituted heteroarylene group having a total atom number of at most 20 and not having 2 or more nitrogen atoms, or a tertiary arylamine. Among these, more preferred are phenylene, biphenylene, terphenylene, naphthylene, fluorene, acenaphthene, phenanthrene, anthracene, fluoranthene, pyrene, perylene, rubrene, chrysene, furan, thiophene, pyrrole, oxazole, isoxazole, thiazole, isothiazole, imidazole, pyridine, benzoxazole, benzothiazole, quinoline, isoquinoline, phenanthridine, acridine, carbazole, diphenylene oxide, triphenylamine, N,N′-diphenylbenzidine, N,N′-diphenyl-1,4-phenylenediamine, diphenylnaphthylamine, tetraarylsilane, diaryldivinylsilane, dialkyldiarylsilane and dialkyldivinylsilane, still more preferred are phenylene, biphenylene, fluorene, anthracene, pyrrole, oxazole, pyridine and quinoline. These each may have one or more substituent. Preferred examples of the substituent include an alkyl group having at most 20 carbon atoms, an aryl group having at most 20 carbon atoms, an aralkyl group having at most 20 carbon atoms, a (thio)alkoxy group having at most 20 carbon atoms, a (thio)aryloxy group having at most 20 carbon atoms, a cyano group, a fluoro group, a chloro group, an alkoxycarbonyl group having at most 20 carbon atoms, an aryloxycarbonyl group having at most 20 carbon atoms, a polyalkylene oxy group, an alkylsulfonyl group and an arylsulfonyl group. Among these, more preferred are an alkyl group, an alkoxy group, a polyalkylene oxy group and a cyano group, and still more preferred are an alkyl group and an alkoxy group.

R¹ is preferably hydrogen atom, an alkyl group having at most 20 carbon atoms, an aryl group having at most 20 carbon atoms, an aralkyl group having at most 20 carbon atoms or a polyalkylene oxy group having at most 20 carbon atoms, more preferably an alkyl group or a polyalkylene oxy group, still more preferably an alkyl group having from 1 to 6 carbon atoms (e.g., methyl, ethyl, propyl, n-butyl, n-hexyl).

The novel polymer having at least a structure represented by formula (I) of the present invention is useful as an electrically conducting polymer, an electron-transporting polymer or an electron-injecting polymer.

The polymer having at least a structure represented by formula (I) of the present invention may be a homopolymer or a copolymer with another monomer and the copolymer may be a random copolymer, an alternate copolymer, a block copolymer or a graft copolymer. The polymer may also be a star burst-type homopolymer or copolymer. Furthermore, as described above, the polymer may be a multiple copolymer where Ar¹ has two kinds of skeletons.

In the present invention, the substance undertaking the luminescence may be the polymer having at least a structure represented by formula (I) or may be another light-emitting polymer or light-emitting low molecular compound. Furthermore, the polymer of the present invention may contain in the compound a skeleton moiety having a hole-transporting function, an electron-transporting function or a light-emitting function.

In formula (I), n is preferably a numerical value of 0 to 70, more preferably from 0 to 50, still more preferably from 0 to 30. In the case where Ar¹ is a substituted fluorene ring alone or an alkoxy-substituted benzene ring alone, if n is a value in the vicinity of 50, the effect of the pyridine ring contributing to the physical properties of the polymer is cancelled by the alkyl-substituted fluorene ring or alkoxy-substituted benzene ring and this is not only disadvantageous in view of electron structure of the polymer, coatability, film-forming property and properties of the device but also decreases the polarity, as a result, the polymer cannot be laminated by coating on a light-emitting material such as polyfluorene.

The average molecular weight of the polymer having at least a structure represented by formula (I) varies depending on the kind of substituents and cannot be indiscriminately specified, however, is preferably from 500 to 1,000,000, more preferably from 700 to 700,000, still more preferably from 1,000 to 500,000.

Specific examples of the polymer having at least a structure represented by formula (I) are set forth below, however, the present invention is by no means limited thereto.

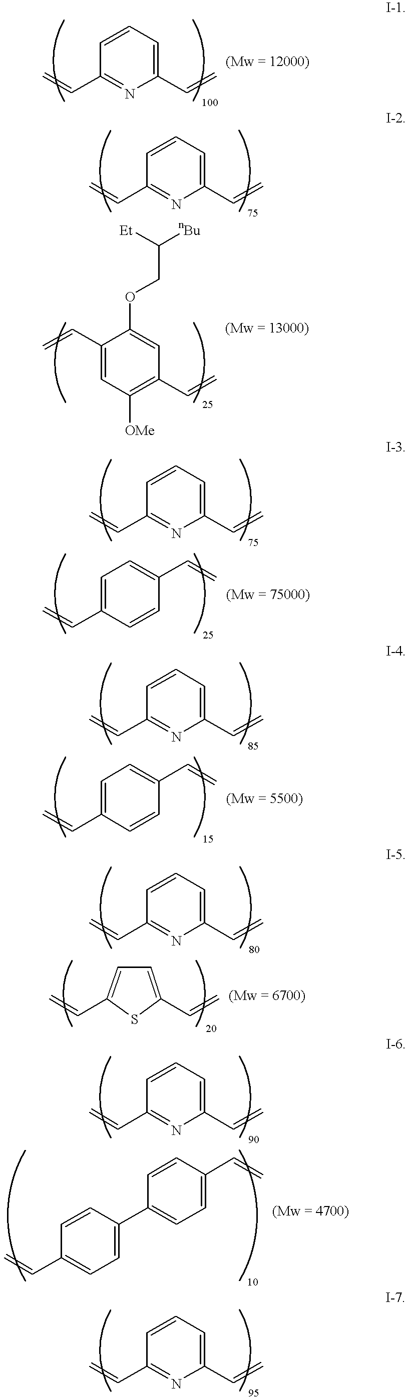

In formula (II), Ar² may have a double bond, a triple bond and/or an aromatic ring in the conjugate system thereof and which to select is determined according to various physical properties of the polymer formed. Ar² may also have two or more skeletons and the polymer as a whole may be a multiple copolymer. Ar² is preferably a substituted or unsubstituted arylene group having a total atom number of at most 20, a substituted or unsubstituted heteroarylene group having a total atom number of at most 20 and not having 2 or more nitrogen atoms, or a tertiary arylamine. Among these, more preferred are phenylene, biphenylene, terphenylene, naphthylene, fluorene, acenaphthene, phenanthrene, anthracene, fluoranthene, pyrene, perylene, rubrene, chrysene, furan, thiophene, pyrrole, oxazole, isoxazole, thiazole, isothiazole, pyridine, benzoxazole, benzothiazole, quinoline, isoquinoline, phenanthridine, acridine, carbazole, diphenylene oxide, triphenylamine, N,N′-diphenylbenzidine, N,N′-diphenyl-1,4-phenylenediamine, diphenylnaphthylamine, tetraarylsilane, diaryldivinylsilane, dialkyldiarylsilane and dialkyldivinylsilane, still more preferred are substituted or unsubstituted phenylene having a total atom number of at most 20, substituted or unsubstituted diphenylene having a total atom number of at most 20, substituted or unsubstituted fluorene having a total atom number of at most 20, substituted or unsubstituted oxazole having a total atom number of at most 20, substituted or unsubstituted 4,6-pyridinediyl having a total atom number of at most 20, substituted or unsubstituted 2,4-pyridinediyl having a total atom number of at most 20, substituted or unsubstituted 2,5-pyridinediyl having a total atom number of at most 20 and substituted or unsubstituted carbazole having a total atom number of at most 20, and particularly preferred are substituted or unsubstituted 4,6-pyridinediyl having a total atom number of at most 20, substituted or unsubstituted 2,4-pyridinediyl having a total atom number of at most 20 and substituted or unsubstituted 2,5-pyridinediyl having a total atom number of at most 20. These each may have one or more substituent. Preferred examples of the substituent include an alkyl group having at most 11 carbon atoms, an aryl group having at most 20 carbon atoms, an aralkyl group having at most 20 carbon atoms, a (thio)alkoxy group having at most 11 carbon atoms, a (thio)aryloxy group having at most 20 carbon atoms, a cyano group, a fluoro group, a chloro group, an alkoxycarbonyl group having at most 11 carbon atoms, an aryloxycarbonyl group having at most 20 carbon atoms, a polyalkylene oxy group having at most 20 carbon atoms, an alkylsulfonyl group having at most 20 carbon atoms and an arylsulfonyl group having at most 20 carbon atoms. Among these, more preferred are an alkyl group, an alkoxy group, a polyalkylene oxy group and a cyano group, and still more preferred are an alkyl group, an aryl group and an alkoxy group.

R² is preferably hydrogen atom, an alkyl group having at most 20 carbon atoms, an aryl group having at most 20 carbon atoms, an aralkyl group having at most 20 carbon atoms or a polyalkylene oxy group having at most 20 carbon atoms, more preferably an alkyl group having at most 15 carbon atoms, an aryl group having at most 15 carbon atoms, an aralkyl group having at most 15 carbon atoms or a polyalkylene oxy group having at most 15 carbon atoms.

The novel polymer having a partial structure represented by formula (II) of the present invention is useful as an electrically conducting polymer, an electron-transporting polymer or an electron-injecting polymer.

The polymer having a partial structure represented by formula (II) of the present invention may be a homopolymer or a copolymer with another monomer and the copolymer may be a random copolymer, an alternate copolymer, a block copolymer or a graft copolymer. The polymer may also be a star burst-type homopolymer or copolymer. Furthermore, as described above, the polymer may be a multiple copolymer where Ar² has two kinds of skeletons.

In the present invention, the substance undertaking the luminescence may be the polymer having a partial structure represented by formula (II) or may be another light-emitting polymer or light-emitting low molecular compound. Furthermore, the polymer of the present invention may contain in the compound a skeleton moiety having a hole-transporting function, an electron-transporting function or a light-emitting function.

In formula (II), p and q each may be any arbitrary value and by varying the values of p and q, the polymer of the present invention can be freely changed in the polarity and the solubility in a solvent. In the case where Ar² is a benzene ring, if two or more positions are substituted by an alkyl group having 12 or more carbon atoms, an alkoxy group having 16 or more carbon atoms, an alkoxycarbonyl group having 12 or more carbon atoms or an acyloxy group, the concentration of the pyridine ring or aromatic ring in the polymer decreases, as a result, electronic effects such as electron affinity, electron-transporting property, light absorption and luminescence, which are the object of the present invention, are conspicuously impaired, therefore, those groups are not preferred as the substituent. Those groups are not preferred also in view of the coatability and properties of the device and if used, the polarity decreases, as a result, there arises a problem that the polymer cannot be laminated by coating on a light-emitting material having low polarity, such as polyfluorene.

The average molecular weight of the polymer having a partial structure represented by formula (II) varies depending on the kind of substituents and cannot be indiscriminately specified, however, is preferably from 500 to 1,000,000, more preferably from 700 to 700,000, still more preferably from 1,000 to 500,000.

Specific examples of the polymer represented by formula (II) are set forth below, however, the present invention is by no means limited thereto.

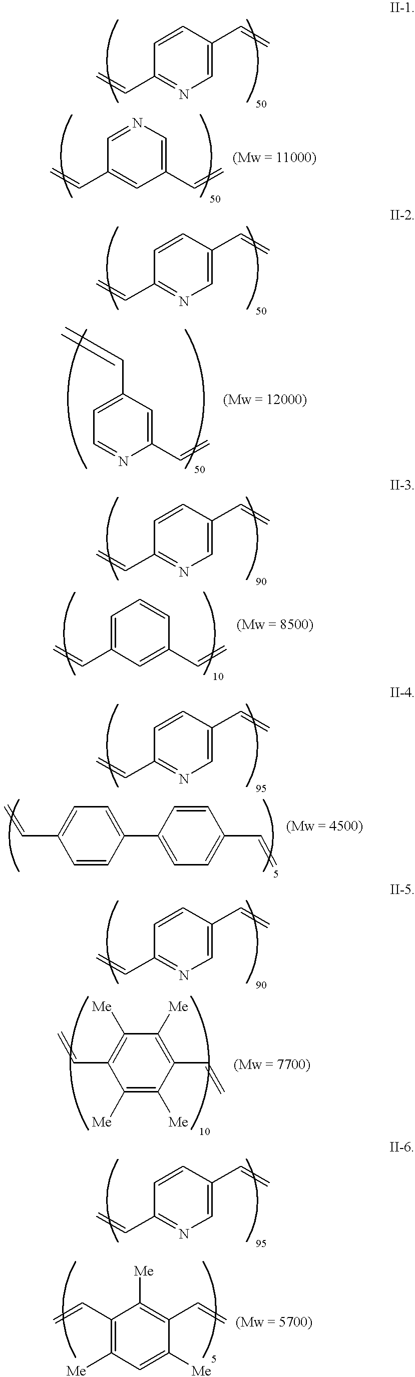

In formula (III), Ar³ and Ar⁴ each may have a double bond, a triple bond and/or an aromatic ring in the conjugate system thereof and which to select is determined according to various physical properties of the polymer formed. Ar³ and Ar⁴ each may also have two or more skeletons and the polymer as a whole may be a multiple copolymer. Furthermore, Ar³ and Ar⁴ each may contain a plurality of other atoms such as oxygen atom and sulfur atom. In particular, the heteroarylene group having 2 or more nitrogen atoms represented by Ar³ is present between two vinylene groups and the two or more nitrogen atoms may be present in a monocyclic or condensed ring constituting the conjugate system or in a monocyclic or condensed ring to which a nitrogen-containing heterocyclic ring constituting the conjugate system is connected directly or indirectly. Ar³ is preferably a nitrogen-containing heterocyclic ring such as pyrazine, dicyanopyrazine, pyrimidine, quinoxaline, dipyridine, triazolopyrimidine, phenanthroline, naphthylidine, imidazole, pyrazole, pyridazine, indazole, purine, phthalazine, quinazoline, cinnoline, pteridine, carboline, primidine, phenadine, oxadiazole (1,2,3-oxadiazole, 1,2,4-oxadiazole, furazane, 1,3,4-oxadiazole), thiadiazine, triazine, thienopyrazine, thiadiazole, benzimidazole, banzothiazole, benzotriazole and benzotriazine. Among these, preferred are pyrazine, dicyanopyrazine, pyrimidine, quinoxaline, dipyridine, triazolopyrimidine, phanthroloine, naphthylidine, imidazole, pyrazole, oxadiazole, triazine, thienopyrazine, benzimidazole, benzothiadiazole, benzotriazole and benzotriazine, more preferred are pyrazine, dicyanopyrazine, pyrimidine, quinoxaline, dipyridine, triazolopyrimidine, phenanthroline, naphthylidine, oxadiazole, triazine, thienopyrazine, benzimidazole, benzotriazole and benzotriazine, still more preferred are quinoxaline and pyrazine. These each may have one or more substituent and may also be formed as a condensed ring.

Preferred examples of the substituent include an alkyl group having at most 11 carbon atoms, an aryl group having at most 20 carbon atoms, an aralkyl group having at most 20 carbon atoms, a (thio)alkoxy group having at most 11 carbon atoms, a (thio)aryloxy group having at most 20 carbon atoms, a cyano group, a fluoro group, a chloro group, an alkoxycarbonyl group having at most 11 carbon atoms, an aryloxycarbonyl group having at most 20 carbon atoms, a polyalkylene oxy group, an alkylsulfonyl group and an arylsulfonyl group. Among these, more preferred are an alkyl group, an aryl group, an alkoxy group, a polyalkylene oxy group, a cyano group and a fluoro group, and still more preferred are an alkyl group, an aryl group, an alkoxy group, a cyano group and a fluoro group.

Ar⁴ is preferably a substituted or unsubstituted arylene group having a total atom number of at most 20, a substituted or unsubstituted heteroarylene group having a total atom number of at most 20 and not having 2 or more nitrogen atoms, or a tertiary arylamine. Among these, more preferred are phenylene, biphenylene, terphenylene, naphthylene, fluorene, acenaphthene, phenanthrene, anthracene, fluoranthene, pyrene, perylene, rubrene, chrysene, furan, thiophene, pyrrole, oxazole, isoxazole, thiazole, isothiazole, imidazole, pyridine, benzoxazole, benzothiazole, quinoline, isoquinoline, phenanthridine, acridine, carbazole, diphenylene oxide, triphenylamine, N,N′-diphenylbenzidine, N,N′-diphenyl-1,4-phenylenediamine, diphenylnaphthylamine, tetraarylsilane, diaryldivinylsilane, dialkyldiarylsilane and dialkyldivinylsilane. These each may have one or more substituent and may also be formed as a condensed ring. Preferred examples of the substituent include an alkyl group having at most 11 carbon atoms, an aryl group having at most 20 carbon atoms, an aralkyl group having at most 20 carbon atoms, a (thio)alkoxy group having at most 11 carbon atoms, a (thio)aryloxy group having at most 20 carbon atoms, a cyano group, a fluoro group, a chloro group, an alkoxycarbonyl group having at most 11 carbon atoms, an aryloxycarbonyl group having at most 20 carbon atoms, a polyalkylene oxy group, an alkylsulfonyl group and an arylsulfonyl group. Among these, more preferred are an alkyl group, an aralkyl group, an alkoxy group, a polyalkylene oxy group, a cyano group and a fluoro group, and still more preferred are an alkyl group, an aralkyl group, an aryl group and an alkoxy group.

The novel polymer having a partial structure represented by formula (III) of the present invention is useful as an electrically conducting polymer, an electron-transporting polymer, an electron-injecting polymer or a light-emitting agent and also useful as a material having a composite of these functions.

The polymer having a partial structure represented by formula (III) of the present invention may be a homopolymer or a copolymer with another monomer and the copolymer may be a random copolymer, an alternate copolymer, a block copolymer or a graft copolymer. The polymer may also be a star burst-type homopolymer or copolymer. Furthermore, as described above, the polymer may be a multiple copolymer where Ar³ and Ar⁴ each has two kinds of skeletons.

In the present invention, the substance undertaking the luminescence may be the polymer having a partial structure represented by formula (III) or may be another light-emitting polymer or light-emitting low molecular compound. Furthermore, the polymer of the present invention may contain in the compound a skeleton moiety having a hole-transporting function, an electron-transporting function or a light-emitting function.

In formula (III), r and s each may be any arbitrary value and by varying the values of r and s, the polymer of the present invention can be freely changed in the polarity and the solubility in a solvent. However, in the case where Ar³ is a 2,2′-dipyridyl-4,4′-diyl group or a 2,5-pyrazinediyl group, if s is 0 and a homopolymer of each compound is formed, the polymer becomes insoluble in almost all solvents and the usefulness in practical use is impaired. Furthermore, if s is 50 and an alternate copolymer is formed, the concentration of the pyridine ring or pyrazine ring in the polymer becomes equal to the concentration of Ar⁴, as a result, the electronic and optical effects such as electron affinity, electron-transporting property, light absorption and luminescence, which are the object of the present invention, are canceled by the properties of Ar⁴ and the properties of either moiety are hardly brought out, therefore, the above-described partial ratio by mol in the polymer is not preferred. In order to bring out the properties of respective moieties, r and s are preferably in the range of 100>r≧60 and 0<s≦40.

Particularly, in the case where Ar³ is 2,2′-dipyridyl-4,4′-diyl group, if Ar⁴ is a benzene ring having no substituent or has a structure analogous thereto, the glass transition temperature is high and the solubility is insufficient, therefore, a good film cannot be formed.

The average molecular weight of the polymer having a partial structure represented by formula (III) varies depending on the kind of substituents and cannot be indiscriminately specified, however, is preferably from 500 to 1,000,000, more preferably from 700 to 700,000, still more preferably from 1,000 to 500,000.

Specific examples of the polymer represented by formula (III) are set forth below, however, the present invention is by no means limited thereto.

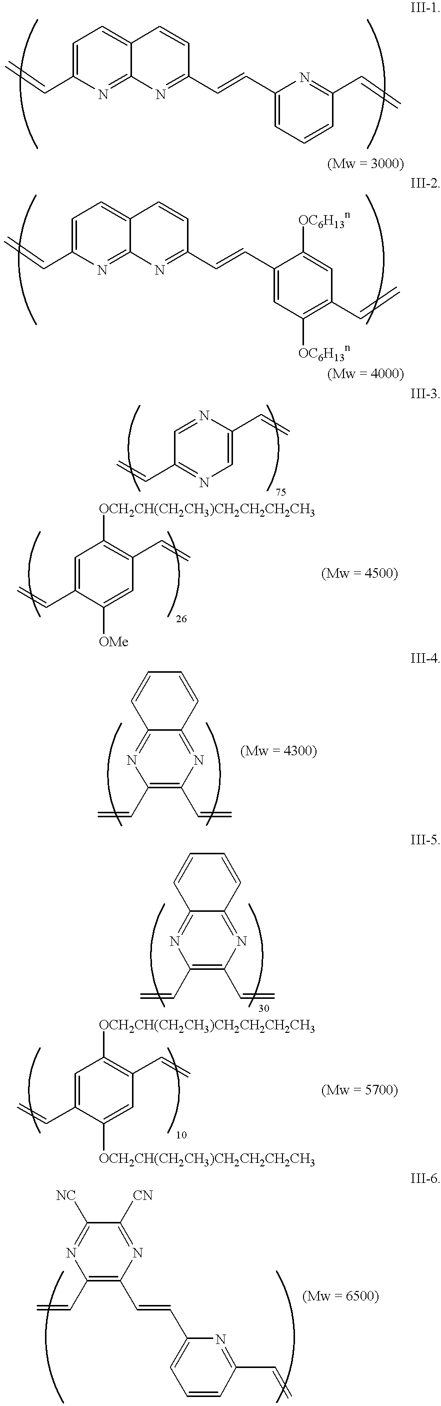

The polymerization method for the polymer having at least one partial structure represented by formula (I) or (II) of the present invention is not particularly limited but, for example, a reaction of bishalomethylarylene in the presence of a base, a condensation reaction of dimethylarylene and diformylarylene, a Wittig reaction and a Suzuki coupling may be used. With respect to the polymerization method for the polymer having at least one partial structure represented by formula (III) of the present invention, a Heck reaction may be used, in addition to the above-described reactions. Examples of the polymerization method include the methods described in WO94/20589, Polymer, Vol. 35, No. 2, p. 391 (1994), and JP-A-7-300580. In the case of using these polymerization methods, unlike radical polymerization, a polymer having a relatively low molecular weight from several hundreds to several thousands is sometimes obtained.

The polymerization solvent is not particularly limited but examples thereof include aromatic hydrocarbon-base solvents (e.g., benzene, toluene), halogenated hydrocarbon-base solvents (e. g., dichloroethane, chloroform) , ether-base solvents (e.g., tetrahydrofuran, dioxane) , amide-base solvents (e.g., dimethylformamide, dimethylacetamide), ester-base solvents (e.g., ethyl acetate), alcohol-base solvents (e.g., methanol), ketone-base solvents (e.g., acetone, cyclohexanone), nitromethane, water and a mixed solvent containing two-phase system solvents thereof. By selecting the solvent, solution polymerization of polymerizing the monomer in a homogeneous system, or precipitation polymerization where the polymer produced precipitates, may be performed.

The solvent and the coating solvent, in which the polymer of the present invention is dissolved, each may be freely selected according to the structure of the polymer. For example, in the case of a highly polar polymer like Compounds I-1, II-1 and III-1, the polymer may be dissolved in various highly polar solvents such as water, methanol, other alcohols, formic acid, acetic acid, cellosolve-base solvent, glycol-base solvent and dioxane, or a mixed solvent thereof. On the other hand, in the case of a low polar polymer like Compounds I-2, II-11 and III-2, the polymer may be dissolved in various low polar solvents such as tetrahydrofuran, halogen-base hydrocarbon solvent and aromatic hydrocarbon solvent. By making good use of these, for example, the polymer of the present invention dissolved in a highly polar solvent can be laminated on a low polar light-emitting polymer such as (substituted) phenylene vinylene-base (co) polymer, (substituted) fluorene-base (co)polymer and (substituted) phenylene-base (co)polymer, only through the coating process without causing any mixing between layers. It is also possible to laminate the polymer of the present invention dissolved in chloroform or the like on a thin film formed by aqueous coating, such as PEDOT-PSS film (polyethylenedioxythiophene-polystyrene sulfonic acid doped product), only through the coating process. Preferred examples of the coating solvent include water, methanol, ethanol, propanol, isopropanol, butanol, formic acid, acetic acid, methyl cellosolve, ethyl cellosolve, ethylene glycol, propylene glycol, dioxane, benzene, toluene, xylene, chloroform, dichloromethane, dichloroethane, tetrahydrofuran and a mixed solvent thereof. Among these, more preferred are water, methanol, ethanol, propanol, isopropanol, acetic acid, methyl cellosolve, ethyl cellosolve, ethylene glycol, dioxane, toluene, chloroform, dichloromethane, dichloroethane, tetrahydrofuran and a mixed solvent thereof.

The thickness of the coating layer formed of the polymer having at least one partial structure represented by formula (II) of the present invention is preferably from 0.1 to 500 nm, more preferably from 1 to 100 nm.

The light-emitting device of the present invention is a device by forming a light-emitting layer or a plurality of organic compound thin films containing a light-emitting layer between a pair of electrodes of anode and cathode. In addition to the light-emitting layer, a hole-injecting layer, a hole-transporting layer, an electron-injecting layer, an electron-transporting layer, a protective layer and the like may be provided. These layers each may have a function other than the function intended. For forming each layer, various materials may be used.

The anode feeds holes to the hole-injecting layer, the hole-transporting layer or the light-emitting layer, and a metal, an alloy, a metal oxide, an electrically conducting compound or a mixture thereof may be used therefor. A material having a work function of 4 eV or more is preferred. Specific examples thereof include electrically conducting metal oxides such as tin oxide, zinc oxide, indium oxide and indium tin oxide (ITO), metals such as gold, silver, chromium and nickel, a mixture or laminate of the metal with the electrically conducting metal oxide, inorganic electrically conducting materials such as copper iodide and copper sulfide, an organic electrically conducting material such as polyaniline, polythiophene and polypyrrole, and a laminate of the material with ITO. Of these, electrically conducting metal oxides are preferred and in view of productivity, high electrical conductivity and transparency, ITO is more preferred. The thickness of the anode may be freely selected depending on the material used, however, it is usually in the range of preferably from 10 nm to 5 μm, more preferably from 50 nm to 1 μm, still more preferably from 100 to 500 nm.

The anode is usually a layer formed on a soda lime glass, an alkali-free glass or a transparent resin substrate. In the case of using a glass, the constructive material therefor is preferably an alkali-free glass so as to reduce the ion dissolved out from the glass. In the case of using a soda lime glass, the glass is preferably subjected to barrier coating with silica or the like. The thickness of the substrate is not particularly limited as long as the substrate can maintain the mechanical strength, however, in the case of using a glass, it is usually 0.2 mm or more, preferably 0.7 mm or more. The anode may be prepared by various methods according to the material used and for example, in the case of ITO, the layer is formed by an electron beam method, a sputtering method, a resistance heating evaporation method, a chemical reaction method (sol-gel process) or a method of coating an indium tin oxide dispersion.

By subjecting the anode to rinsing or other treatments, the device driving voltage can be lowered or the luminescence efficiency can be increased. For example, in the case of ITO, a UV-ozone treatment and a plasma treatment are effective.

The cathode feeds electrons to the electron-injecting layer, the electron-transporting layer or the light-emitting layer and is selected by taking account of the adhesion to the layer adjacent to the negative electrode, such as an electron-injecting layer, an electron-transporting layer and a light-emitting layer, the ionization potential and the stability. As the material for the cathode, a metal, an alloy, a metal halide, a metal oxide, an electrically conducting compound or a mixture thereof may be used and specific examples thereof include an alkali metal (e.g., Li, Na, K) and a fluoride thereof, an alkaline earth metal (e.g., Mg, Ca) and a fluoride thereof, gold, silver, lead, aluminum, a sodium-potassium alloy or mixed metal, a lithium-aluminum alloy or mixed metal, a magnesium-silver alloy or mixed metal, and a rare earth metal such as indium and ytterbium. Among these, preferred are materials having a work function of 4 eV or less, more preferred are aluminum, a lithium-aluminum alloy or mixed metal, and a magnesium-silver alloy or mixed metal. The cathode may have not only a single layer structure of the above-described compound or a mixture of those compounds but also a laminate structure containing the above-described compound or a mixture of those compounds. The thickness of the cathode may be freely selected depending on the material used, however, it is usually in the range of preferably from 10 nm to 5 μm, more preferably from 50 nm to 1 μm, still more preferably from 100 nm to 1 μm. The cathode may be manufactured by an electron beam method, a sputtering method, a resistance heating evaporation method or a coating method, and a sole metal may be deposited or two or more components may be simultaneously deposited. Furthermore, a plurality of metals may be co-deposited to form an alloy electrode or an alloy previously prepared may be deposited. The anode and the cathode each preferably has a low sheet resistance of 15 Ω/□ or less.

The material for the light-emitting layer may be any as long as it can form a layer having a function of injecting holes from the anode, hole-injecting layer or hole-transporting layer and at the same time injecting electrons from the cathode, electron-injecting layer or electron-transporting layer upon application of an electric field, a function of transferring charges injected, or a function of offering a chance to the hole and the electron to recombine and emit light. The light-emitting layer is preferably a layer containing a conjugate unsaturated compound but the polymer of the present invention or other light-emitting materials may also be used. Examples thereof include various metal complexes including metal complexes and rare earth complexes of benzoxazole derivative, benzimidazole derivative, benzothiazole derivative, styrylbenzene derivative, polyphenyl derivative, diphenylbutadiene derivative, tetraphenylbutadiene derivative, naphthalimide derivative, coumarin derivative, perylene derivative, perynone derivative, oxadiazole derivative, aldazine derivative, pyralidine derivative, cyclopentadiene derivative, bisstyrylanthracene derivative, quinacridone derivative, pyrrolopyridine derivative, thiazolopyridine derivative, cyclopentadiene derivative, styrylamine derivative, aromatic dimethylidyne compound and 8-quinolinol derivative, and polymer compounds such as (substituted) polythiophene, (substituted) polyphenylene, (substituted) polyfluorene and (substituted) polyphenylenevinylene. The thickness of the light-emitting layer is not particularly limited, however, it is usually in the range of preferably from 1 nm to 5 μm, more preferably from 5 nm to 1 μm, still more preferably from 10 to 500 nm.

The method for forming the light-emitting layer is not particularly limited and a resistance heating evaporation method, an electron beam method, a sputtering method, a molecular lamination method, a coating method (e.g., spin coating, casting, dip coating), an ink jet method, a printing method or an LB method may be used. Among these, preferred are a resistance heating evaporation method and a coating method.

The material for the hole-injecting layer and the hole-transporting layer may be any as long as it has any one of a function of injecting holes from the anode, a function of transporting holes and a function of blocking electrons injected from the cathode. The polymer of the present invention may be used or other materials may also be used. Specific examples thereof include electrically conducting high molecular oligomers such as carbazole derivative, triazole derivative, oxazole derivative, oxadiazole derivative, imidazole derivative, polyarylalkane derivative, pyrazoline derivative, pyrazolone derivative, phenylenediamine derivative, arylamine derivative, amino-substituted chalcone derivative, styrylanthracene derivative, fluorenone derivative, hydrazone derivative, stilbene derivative, silazane derivative, aromatic tertiary amine compound, styrylamine compound, aromatic dimethylidyne-base compound, porphyrin-base compound, polysilane-base compound, poly(N-vinylcarbazole) derivative, aniline-base copolymer, thiophene oligomer, polythiophene and (substituted) polythiophene-polystyrene sulfonic acid mixture. The hole-injecting layer and the hole-transporting are not particularly limited on the thickness, however, the thickness is usually in the range of preferably from 1 nm to 5 μm, more preferably from 5 nm to 1 μm, still more preferably from 10 to 500 nm. The hole-injecting layer and the hole-transporting layer each may have a single layer structure comprising one or more of the above-described materials or may have a multi-layer structure comprising a plurality of layers which are the same or different in the composition.

The hole-injecting layer and the hole-transporting layer each is formed by a vacuum evaporation method, an LB method, an ink jet method, a printing method or a method of dissolving or dispersing the above-described hole-injecting and transporting agent in a solvent and coating the solution (e.g., spin coating, casting, dip coating). In the case of the coating method, the material can be dissolved or dispersed together with a resin component. Examples of the resin component include polyvinyl chloride, polycarbonate, polystyrene, polymethyl methacrylate, polybutyl methacrylate, polyester, polysulfone, polyphenylene oxide, polybutadiene, poly(N-vinylcarbazole), hydrocarbon resin, ketone resin, phenoxy resin, polyamide, ethyl cellulose, vinyl acetate, ABS resin, polyurethane, melamine resin, unsaturated polyester resin, alkyd resin, epoxy resin and silicone resin.

The material for the electron-injecting layer and electron-transporting layer may be any as long as it has any one of a function of injecting electrons from the cathode, a function of transporting electrons and a function of blocking holes injected from the anode. Specific examples thereof include heterocyclic tetracarboxylic acid anhydrides such as triazole derivative, oxazole derivative, oxadiazole derivative, fluorenone derivative, anthraquinodimethane derivative, anthrone derivative, diphenylquinone derivative, thiopyran dioxide derivative, carbodiimide derivative, fluorenylidenemethane derivative, distyrylpyrazine derivative and naphthalene perylene, and various metal complexes such as metal complex of phthalocyanine derivative or 8-quinolinol derivative, and metal complex containing metal phthalocyanine, benzoxazole or benzothiazole as a ligand. The electron-injecting layer and the electron-transporting layer are not particularly limited on the thickness, however, the thickness is usually in the range of preferably from 1 nm to 5 μm, more preferably from 5 nm to 1 μm, still more preferably from 10 to 500 nm. The electron-injecting layer and the electron-transporting layer each may have a single layer structure comprising one or more of the above-described materials or may have a multi-layer structure comprising a plurality of layers which are the same or different in the composition.

The electron-injecting layer and the electron-transporting layer each is formed by a vacuum evaporation method, an LB method, an ink jet method, a printing method or a method of dissolving or dispersing the above-described electron-injecting and transporting agent in a solvent and coating the solution (e.g., spin coating, casting, dip coating). In the case of the coating method, the material can be dissolved or dispersed together with a resin component. Examples of the resin component include those described for the hole-injecting and transporting layer.

The material for the protective layer may any as long as it has a function of preventing a substance which accelerates deterioration of the device, such as moisture and oxygen, from entering the device. Specific examples thereof include metals such as In, Sn, Pb, Au, Cu, Ag, Al, Ti and Ni, metal oxides such as MgO, SiO, SiO₂, Al₂O₃, GeO, NiO, CaO, BaO, Fe₂O₃, Y₂O₃ and TiO₂, metal fluorides such as MgF₂, LiF, AlF₃ and CaF₂, polyethylene, polypropylene, polymethyl methacrylate, polyimide, polyurea, polytetrafluoroethylene, polychlorotrifluoroethylene, polydichlorodifluoroethylene, a copolymer of chlorotrifluoroethylene and dichlorodifluoroethylene, a copolymer obtained by copolymerizing a monomer mixture containing tetrafluoroethylene and at least one comonomer, a fluorine-containing copolymer having a cyclic structure in the copolymer main chain, a water absorptive substance having a coefficient of water absorption of 1% or more, and a moisture-proofing substance having a coefficient of water absorption of 0.1% or less.

The method for forming the protective layer is not particularly limited and, for example, a vacuum evaporation method, a sputtering method, a reactive sputtering method, an MBE (molecular beam epitaxy) method, a cluster ion beam method, an ion plating method, a plasma polymerization method (high frequency exciting ion plating method), a plasma CVD method, a laser CVD method, a thermal CVD method, a gas source CVD method, an ink jet method, a printing method and a coating method may be used.

The present invention is described in greater detail below by referring to the Examples, however, the present invention should not be construed as being limited thereto.

### EXAMPLE 1

(Synthesis of Compound I-1)

Into a 200 ml-volume flask, 60 ml of dry tetrahydrofuran (THF) and 2.20 g (19.60 mmol, 6.9 equivalent) of t-BuOK were charged in a nitrogen stream and dissolved while stirring. Subsequently, a THF solution (10 ml) of 2,6-bis(chloromethyl)pyridine (0.5 g, 2.84 mmol) was added dropwise over 20 minutes. The resulting solution was then stirred at room temperature for 20 hours. Thereafter, the reaction mixture was added dropwise to a mixed solvent of ethyl acetate and THF and the precipitate produced was separated by filtration and vacuum-dried to obtain 0.19 g of the polymer of Compound I-1. Yield: 65%. This polymer was measured on the molecular weight by gel permeation chromatography (GPC) (in terms of polystyrene standard, MeOH/water elution) and found to have a weight average molecular weight of 12,000 and a number average molecular weight of 9,800. This polymer was soluble in water and in MeOH.

### EXAMPLE 2

(Synthesis of Compound 1-2)

0.35 g of the polymer of Compound I-2 was obtained thoroughly in the same manner as in Example 1 except that the THF solution of 2,6-bis(chloromethyl)pyridine (0.5 g, 2.84 mmol) was replaced by a THF solution containing 2,6-bis(chloromethyl)pyridine (0.375 g, 2.13 mmol) and 2,5-bis(chloromethyl)-1-(2-ethylhexyloxy)-4-methoxybenzene (0.237 g, 0.71 mmol). Yield: 70%. This polymer was measured on the molecular weight by GPC (in terms of polystyrene standard, THF elution) and found to have a weight average molecular weight of 13,000 and a number average molecular weight of 11,000. This polymer was soluble in chloroform.

### EXAMPLE 3

(Synthesis of Compound I-23)

Into a 100 ml-volume three-neck flask, 0.956 g (0.915 mmol) of phosphonium salt obtained by reacting 2,5-bis(chloromethyl)-1,4-di-n-octyloxybenzene and triphenylphosphine, 0.0268 g (0.200 mmol) of isophthalaldehyde, 0.108 g (0.798 mmol) of 2,6-pyridinedicarboxyaldehyde and 25 ml of ethanol were charged in a nitrogen stream and stirred at room temperature. Subsequently, an ethanol solution of sodium ethoxide (sodium ethoxide: 3 mmol, ethanol: 5 ml) was added dropwise and the resulting solution was stirred at room temperature for 15 hours. The gum-like precipitate produced was taken out and washed with ethanol and then, the precipitate was dissolved in chloroform and purified by the reprecipitation in ethanol. Thereafter, the precipitate was vacuum-dried to obtain 0.25 g of the objective polymer. Yield: 55%. The polymer obtained had a weight average molecular weight of 7,200, and a number average molecular weight of 24,500.

### EXAMPLE 4

On a washed ITO substrate, a PPV precursor solution (produced by Cambridge Display Technology) was spin-coated and then vacuum-dried at 150° C. for 2 hours to form a PPV film (film thickness: about 100 nm). On this film, a solution obtained by dissolving 20 mg of the polymer of Compound I-1 in 2 ml of methanol was spin-coated (3,000 rpm, 20 seconds) (film thickness: about 20 nm) Subsequently, on this organic thin film, a mask subjected to a patterning (to have a luminescence area of 5 mm×5 mm) was provided and in an evaporation apparatus, magnesium and silver (10:1) were co-deposited to 250 nm and then silver was deposited to 300 nm (1.0×10⁻³ to 1.3×10⁻³ Pa).

The luminescence properties were measured as follows.

Light was emitted using ITO as the anode and Mg:Ag as the cathode by applying a d.c. constant voltage to the EL device in Source Measure Unit Model 2400 manufactured by Toyo Technica, and the luminance and the emission wavelength were measured using Luminance Meter BM-8 (manufactured by Topcon KK) and Spectrum Analyzer PMA-11 (manufactured by Hamamatsu Photonics KK), respectively. Furthermore, by allowing the fabricated device to stand under the conditions of 60° C. and 20% RH for 3 hours and then emitting light, a relative luminance (a luminance after aging as a relative value to the luminance immediately after the fabrication of the device which is taken as 100 (driving voltage: 10 V)) was evaluated. As a result, luminescence was observed from 3 V, and a current density of 1,035 mA/cm² and a green emission of 501 Cd/sqm were exhibited at 7 V. The emission wavelength λmax was present in 500 nm. The relative luminance after aging was 78.

### EXAMPLE 5

A device of ITO/PPV (100 nm)/Compound I-2 (50 nm)/Mg—Ag was fabricated in the same manner as in Example 4.

The luminescence properties were measured in the same manner as in Example 4. As a result, a current density of 300 mA/cm² and a green emission of 953 Cd/sqm were exhibited at 16 V. The emission wavelength λmax was present in 575 nm and 617 nm. The relative luminance after aging was 82.

### EXAMPLE 6

On a washed ITO substrate, Baytron P (PEDOT-PSS solution (polyethylenedioxythiophene-polystyrene sulfonic acid doped product, produced by Bayer) was spin-coated at 2,000 rpm within 60 seconds and then vacuum-dried at 100° C. for 1 hour to form a hole-transporting film (film thickness: about 100 nm). On this film, a solution obtained by dissolving 20 mg of poly(9,9-dioctylfluorene) in 2 ml of chloroform was spin-coated (1,000 rpm, 20 seconds) (film thickness: about 70 nm) and further thereon, a solution obtained by dissolving 20 mg of the polymer of Compound I-1 in 2 ml of methanol was spin-coated (5,000 rpm, 20 seconds) (film thickness: about 10 nm). Subsequently, on this organic thin film, a mask subjected to a patterning (to have a luminescence area of 5 mm×5 mm) was provided and in an evaporation apparatus, aluminum was deposited to 400 nm.

The luminescence properties were measured in the same manner as in Example 4. As a result, a current density of 657 mA/cm² and a blue emission of 5,180 Cd/sqm were exhibited at 10 V. The emission wavelength λmax was present in 430 nm. The relative luminance after aging was 77.

### EXAMPLE 7

A device of ITO/poly(9,9-dioctylfluorene) (100 nm)/Compound I-9 (30 nm)/Al was fabricated in the same manner as in Example 6.

The luminescence properties were measured in the same manner as in Example 4. As a result, a current density of 200 mA/cm² and a blue emission of 1,126 Cd/sqm were exhibited at 5 V. The emission wavelength λmax was present in 431 nm. The relative luminance after aging was 85.

### COMPARATIVE EXAMPLE 1

A device of ITO/polyphenylenevinylene (50 nm)/Mg—Ag was fabricated and measured on the luminescence properties in the same manner as in Example 4. As a result, luminescence was observed from 4 V and when a voltage of 8 V was applied, the current value was 2,025 mA/cm² and only a luminance as low as 120 Cd/sqm was exhibited. The emission wavelength λmax was present in 500 nm. The relative luminance after aging was 28.

### COMPARATIVE EXAMPLE 2

A device of ITO/polyphenylenevinylene (50 nm)/poly(2,5-pyridinediyl) (30 nm)/Mg—Ag was fabricated and measured on the luminescence properties in the same manner as in Example 5. As a result, when a voltage of 8 V was applied, the current value was 25 mA/cm² and only a luminance as low as 135 Cd/sqm was exhibited. The emission wavelength λmax was present in 540 nm and the emission from polyphenylenevinylene was not obtained. The relative luminance after aging was 28.

### COMPARATIVE EXAMPLE 3

A device of ITO/poly(9,9-dioctylfluorene) (100 nm)/Comparative Compound 1 (30 nm)/Al was tried to fabricate in the same manner as in Example 6, however, due to approximation between the polarity of the coating solvent system (halogen-base hydrocarbon or THF) of poly(9,9-dioctylfluorene) and the polarity of the coating solvent system (halogen-base hydrocarbon or THF) of Comparative Compound 1, mixing of layers was generated at the lamination coating and a device having a laminate structure could not be fabricated. The device having this layer mixing was measured on the luminescence properties in the same manner as in Example above but light was not emitted at all.

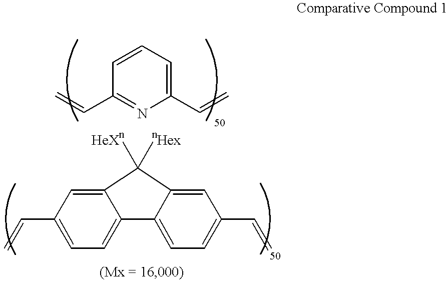

### COMPARATIVE EXAMPLE 4

A device of ITO/poly(9,9-dioctylfluorene) (100 nm)/Comparative Compound 2 (30 nm)/Al was tried to fabricate in the same manner as in Example 6, however, due to approximation between the polarity of the coating solvent system (halogen-base hydrocarbon or THF) of poly(9,9-dioctylfluorene) and the polarity of the coating solvent system (halogen-base hydrocarbon or THF) of Comparative Compound 2, mixing of layers was generated at the lamination coating and a device having a laminate structure could not be fabricated. The device having this layer mixing was measured on the luminescence properties in the same manner as in Example above but light was not emitted at all.

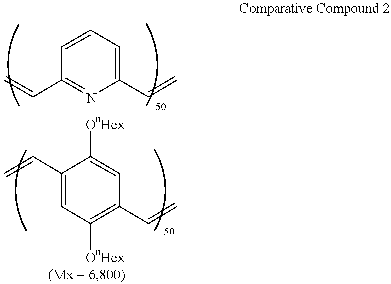

### EXAMPLE 8

(Synthesis of Compound II-1)

Into a 200 ml-volume flask, 60 ml of dry tetrahydrofuran (THF) and 2.20 g (19.60 mmol, 6.9 equivalent) of t-BuOK were charged in a nitrogen stream and dissolved while stirring. Subsequently, a THF solution (10 ml) containing 2,5-bis(chloromethyl)pyridine (0.25 g, 1.42 mmol) and 3,5-bis(chloromethyl)pyridine (0.25 g, 1.42 mmol) was added dropwise over 20 minutes. The resulting solution was then stirred at room temperature for 20 hours. Thereafter, the reaction mixture was added dropwise to a mixed solvent of ethyl acetate and THF and the precipitate produced was separated by filtration and vacuum-dried to obtain 0.23 g of the polymer of Compound II-1. Yield: 78%. This polymer was measured on the molecular weight by gel permeation chromatography (GPC) (in terms of polystyrene standard, MeOH/water elution) and found to have a weight average molecular weight of 11,000 and a number average molecular weight of 9,900. This polymer was soluble in water and in MeOH.

### EXAMPLE 9

(Synthesis of Compound II-2)

0.19 g of the polymer of Compound II-2 was obtained thoroughly in the same manner as in Example 8 except that the THF solution of 3,5-bis(chloromethyl)pyridine was replaced by a THF solution of 2,4-bis(chloromethyl)pyridine. Yield: 65%. This polymer was measured on the molecular weight by GPC (in terms of polystyrene standard, THF elution) and found to have a weight average molecular weight of 12,000 and a number average molecular weight of 11,000. This polymer was soluble in water and in MeOH.

### EXAMPLE 10

(Synthesis of Compound II-16)

Into a 100 ml-volume three-neck flask, 0.956 g (0.915 mmol) of phosphonium salt obtained by reacting 2,5-bis(chloromethyl)-1,4-di-n-octyloxybenzene and triphenylphosphine, 0.0268 g (0.200 mmol) of isophthalaldehyde, 0.108 g (0.798 mmol) of 2,5-pyridinedicarboxyaldehyde and 25 ml of ethanol were charged in a nitrogen stream and stirred at room temperature. Subsequently, an ethanol solution of sodium ethoxide (sodium ethoxide: 3 mmol, ethanol: 5 ml) was added dropwise and the resulting solution was stirred at room temperature for 15 hours. The gum-like precipitate produced was taken out and washed with ethanol and then, the precipitate was dissolved in chloroform and purified by the reprecipitation in ethanol. Thereafter, the precipitate was vacuum-dried to obtain 0.25 g of the objective polymer. Yield: 55%. The polymer obtained had a weight average molecular weight of 7,200, and a number average molecular weight of 24,500.

### EXAMPLE 11

A device of ITO/PPV (100 nm)/Compound II-1 (20 nm)/Mg—Ag was fabricated in the same manner as in Example 4.

The luminescence properties were measured in the same manner as in Example 4. As a result, luminescence was observed from 3 V and a current density of 1,050 mA/cm² and a green emission of 370 Cd/sqm were exhibited at 7 V. The emission wavelength λmax was present in 500 nm. The relative luminance after aging was 85.

### EXAMPLE 12

A device of ITO/PPV (100 nm)/Compound II-7 (50 nm)/Mg—Ag was fabricated in the same manner as in Example 11.

The luminescence properties were measured in the same manner as in Example 11. As a result, a current density of 380 mA/cm² and an emission of 757 Cd/sqm were exhibited at 16 V. The emission wavelength λmax was present in 575 nm and 617 nm. The relative luminance after aging was 78.

### EXAMPLE 13

A device of ITO/poly(9,9-dioctylfluorene) (70 nm)/Compound II-1 (10 nm)/Al was fabricated in the same manner as in Example 6.

The luminescence properties were measured in the same manner as in Example 11. As a result, a current density of 837 mA/cm² and a blue emission of 2,770 Cd/sqm were exhibited at 10 V. The emission wavelength λmax was present in 430 nm. The relative luminance after aging was 86.

### EXAMPLE 14

A device of ITO/poly(9,9-dioctylfluorene) (100 nm)/Compound II-2 (30 nm)/Al was fabricated in the same manner as in Example 13.

The luminescence properties were measured in the same manner as in Example 11. As a result, a current density of 200 mA/cm² and a blue emission of 1,126 Cd/sqm were exhibited at 5 V. The emission wavelength λmax was present in 431 nm. The relative luminance after aging was 87.

### COMPARATIVE EXAMPLE 5

A device of ITO/polyphenylenevinylene (50 nm)/Mg—Ag was fabricated and measured on the luminescence properties in the same manner as in Example 11. As a result, luminescence was observed from 4 V and when a voltage of 8 V was applied, the current value was 2,025 mA/cm² and only a luminance as low as 120 Cd/sqm was exhibited. The emission wavelength λmax was present in 500 nm. The relative luminance after aging was 28.

### COMPARATIVE EXAMPLE 6

A device of ITO/polyphenylenevinylene (50 nm)/poly(2,5-pyridinediyl) (30 nm)/Mg—Ag was fabricated and measured on the luminescence properties in the same manner as in Example 12. As a result, when a voltage of 8 V was applied, the current value was 25 mA/cm and only a luminance as low as 135 Cd/sqm was exhibited. The emission wavelength λmax was present in 540 nm and the emission from polyphenylenevinylene was not obtained. The relative luminance after aging was 28.

### COMPARATIVE EXAMPLE 7

A device of ITO/poly(9,9-dioctylfluorene) (100 nm)/Comparative Compound 3 (30 nm)/Al was tried to fabricate in the same manner as in Example 13, however, due to approximation between the polarity of the coating solvent system (halogen-base hydrocarbon or THF) of poly(9,9-dioctylfluorene) and the polarity of the coating solvent system (halogen-base hydrocarbon or THF) of Comparative Compound 3, mixing of layers was generated at the lamination coating and a device having a laminate structure could not be fabricated. The device having this layer mixing was measured on the luminescence properties in the same manner as in Example above but light was not emitted at all.

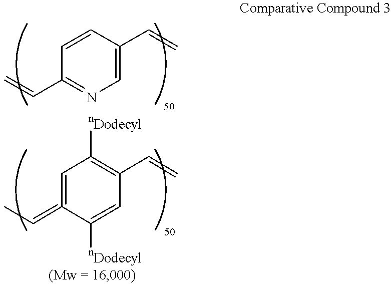

### COMPARATIVE EXAMPLE 8

A device of ITO/poly(9,9-dioctylfluorene) (100 nm)/Comparative Compound 4 (30 nm)/Al was tried to fabricate in the same manner as in Example 13, however, due to approximation between the polarity of the coating solvent system (halogen-base hydrocarbon or THF) of poly(9,9-dioctylfluorene) and the polarity of the coating solvent system (halogen-base hydrocarbon or THF) of Comparative Compound 4, mixing of layers was generated at the lamination coating and a device having a laminate structure could not be fabricated. The device having this layer mixing was measured on the luminescence properties in the same manner as in Example above but light was not emitted at all.

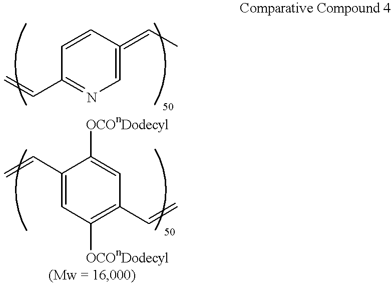

### EXAMPLE 15

(Synthesis of Compound III-3)

Into a 200 ml-volume flask, 60 ml of dry tetrahydrofuran (THF) and 2.20 g (19.60 mmol) of t-BuOK were charged in a nitrogen stream and dissolved while stirring. Subsequently, a THF solution (10 ml) containing 0.237 g (0.71 mmol) of 2,5-bis(chloromethyl)-1-(2-ethylhexyloxy)-4-methoxybenzene and 0.377 g (2.13 mmol) of 2,5-bis(chloromethyl)pyrazine was added dropwise over 20 minutes. The resulting solution was then stirred at room temperature for 20 hours. Thereafter, the reaction mixture was added dropwise to methanol and the precipitate produced was separated by filtration and vacuum-dried to obtain 0.23 g of the polymer of Compound III-3. This polymer was measured on the molecular weight by gel permeation chromatography (GPC) (in terms of polystyrene standard, THF elution) and found to have a weight average molecular weight of 4,500 and a number average molecular weight of 3,800. This polymer was soluble in chloroform.

### EXAMPLE 16

(Synthesis of Compound III-4)

Into a 200 ml-volume flask, 60 ml of dry tetrahydrofuran (THF) and 1.25 g (11.1 mmol) of t-BuOK were charged in a nitrogen stream and dissolved while stirring. Subsequently, a THF solution (10 ml) of 0.5056 g (1.6 mmol) of 2,3-bis(bromomethyl)quinoxaline was added dropwise over 20 minutes. The resulting solution was then stirred at room temperature for 20 hours, as a result, a black polymer precipitate was produced. The precipitate produced was separated by filtration and vacuum-dried to obtain 0.35 g of the polymer of Compound III-4. This polymer was measured on the molecular weight by gel permeation chromatography (GPC) (in terms of polystyrene standard, developed solvent: THF) and found to have a weight average molecular weight of 4,300 and a number average molecular weight of 3,900. This polymer was soluble in water, in MeOH and in acetic acid.

### EXAMPLE 17

(Synthesis of Compound III-5)

0.10 g of the polymer of Compound III-5 was obtained thoroughly in the same manner as in Example 15 except that the THF solution of 2,3-bis(bromomethyl)quinoxaline was replaced by a THF mixed solution containing 0.4551 g (1.44 mmol) of 2,3-bis(bromomethyl)quinoxaline and 0.0833 g (0.16 mmol) of 1,4-bis(bromomethyl)-2,5-bis(2-ethylhexyloxy)-benzene. This polymer was measured on the molecular weight by gel permeation chromatography (GPC) (in terms of polystyrene standard, developed solvent: MeOH/water) and found to have a weight average molecular weight of 5,700 and a number average molecular weight of 5,100. This polymer was soluble in MeOH and in acetic acid.

### EXAMPLE 18

(Synthesis of Compound III-14)

Into a 100 ml-volume flask, 6 ml of dimethylaniline, 6 ml of dimethylformamide, 0.500 g (3.7 mmol) of 2,6-pyridinedicarboxaldehyde, 0.548 g (3.7 mmol) of 5,7-dimethyltriazolopyrimidine and 0.3 g of zinc(II) chloride were charged in a nitrogen stream and stirred at 150° C. for 12 hours. The reaction mixture was reprecipitated with methanol and filtered to obtain 0.95 g of the polymer of Compound III-14. This polymer was measured on the molecular weight by gel permeation chromatography (GPC) (in terms of polystyrene standard, THF elution) and found to have a weight average molecular weight of 2,700 and a number average molecular weight of 2,500. This polymer was soluble in chloroform.

### EXAMPLE 19

(Synthesis of Compound III-12)

1.20 g of the polymer of Compound III-12 was obtained thoroughly in the same manner as in Example 18 except that 0.548 g of 5,7-dimethyltriazolopyrimidine was replaced by 0.804 g of neocuproine hydrate. This polymer was measured on the molecular weight by gel permeation chromatography (GPC) (in terms of polystyrene standard, THF elution) and found to have a weight average molecular weight of 1,500. This polymer was soluble in chloroform.

### EXAMPLE 20

(Synthesis of Compound III-22)

0.92 g of the polymer of Compound III-22 was obtained thoroughly in the same manner as in Example 18 except that 0.548 g of 5,7-dimethyltriazolopyrimidine was replaced by 0.682 g of 4,4′-dimethyl-2,2′-dipyridyl. This polymer was measured on the molecular weight by gel permeation chromatography (GPC) (in terms of polystyrene standard, THF elution) and found to have a weight average molecular weight of 1,700. This polymer was soluble in chloroform.

### EXAMPLE 21

(Synthesis of Compound III-10)

0.78 g of the polymer of Compound III-10 was obtained thoroughly in the same manner as in Example 18 except that 0.548 g of 5,7-dimethyltriazolopyrimidine was replaced by 0.585 g of 2,3-dimethylquinoxaline, and the reaction mixture was reprecipitated with ethyl acetate and purified by washing with methanol. This polymer was measured on the molecular weight by gel permeation chromatography (GPC) (in terms of polystyrene standard, THF elution) and found to have a weight average molecular weight of 5,200. This polymer was soluble in chloroform.

### EXAMPLE 22

(Synthesis of Compound III-8)

0.68 g of the polymer of Compound III-8 was obtained thoroughly in the same manner as in Example 18 except that 0.548 g of 5,7-dimethyltriazolopyrimidine was replaced by 0.40 g of 2,5-dimethylpyrazine, and the reaction mixture was reprecipitated with ethyl acetate and purified by washing with methanol. This polymer was measured on the molecular weight by gel permeation chromatography (GPC) (in terms of polystyrene standard, THF elution) and found to have a weight average molecular weight of 2,800. This polymer was soluble in chloroform.

### EXAMPLE 23

(Synthesis of Compound III-7)

0.65 g of the polymer of Compound III-7 was obtained thoroughly in the same manner as in Example 18 except that 0.548 g of 5,7-dimethyltriazolopyrimidine was replaced by 0.40 g of 3,5-dimethylpyrazine, and the reaction mixture was reprecipitated with ethyl acetate and purified by washing with methanol. This polymer was measured on the molecular weight by gel permeation chromatography (GPC) (in terms of polystyrene standard, THF elution) and found to have a weight average molecular weight of 2,500. This polymer was soluble in chloroform.

### EXAMPLE 24

(Synthesis of Compound III-6)

0.76 g of the polymer of Compound III-6 was obtained thoroughly in the same manner as in Example 18 except that 0.548 g of 5,7-dimethyltriazolopyrimidine was replaced by 0.585 g of 5,6-dimethyl-2,3-pyrazinedicarbonitrile, and the reaction mixture was reprecipitated with ethyl acetate and purified by washing with methanol. This polymer was measured on the molecular weight by gel permeation chromatography (GPC) (in terms of polystyrene standard, THF elution) and found to have a weight average molecular weight of 6,500. This polymer was soluble in chloroform.

### EXAMPLE 25

(Synthesis of Compound III-1)

Into a 100 ml-volume flask, 6 ml of dimethylaniline, 0.427 g (3.16 mmol) of 2,6-pyridinedicarboxaldehyde, 0.50 g (3.16 mmol) of 2,7-dimethylnaphthylidine and 0.25 g of zinc(II) chloride were charged in a nitrogen stream and stirred at 150° C. for 12 hours. The reaction mixture was reprecipitated with hexane, filtered and then washed with water to obtain 0.55 g of the polymer of Compound III-1. This polymer was measured on the molecular weight by gel permeation chromatography (GPC) (in terms of polystyrene standard, THF elution) and found to have a weight average molecular weight of 3,000. This polymer was soluble in chloroform.

### EXAMPLE 26

(Synthesis of Compound III-2)

Into a 100 ml-volume flask, 6 ml of dimethylaniline, 0.529 g (1.58 mmol) of 2,5-bis(n-hexyloxy)-1,4-benzenedicarboxaldehyde, 0.25 g (1.58 mmol) of 2,7-dimethylnaphthylidine and 0.215 g of zinc(II) chloride were charged in a nitrogen stream and stirred at 150° C. for 12 hours. The reaction mixture was reprecipitated with hexane, filtered and then washed with water to obtain 0.55 g of the polymer of Compound III-2. This polymer was measured on the molecular weight by gel permeation chromatography (GPC) (in terms of polystyrene standard, THF elution) and found to have a weight average molecular weight of 4,000. This polymer was soluble in chloroform.

### EXAMPLE 27

On a washed ITO substrate, a PPV precursor solution (produced by Cambridge Display Technology) was spin-coated and then vacuum-dried at 150° C. for 2 hours to form a PPV film (film thickness: about 100 nm). On this film, a solution obtained by dissolving 20 mg of the polymer of Compound III-1 in 2 ml of methanol was spin-coated (5,000 rpm, 20 seconds) (film thickness: about 20 nm). Subsequently, on this organic thin film, a mask subjected to a patterning (to have a luminescence area of 5 mm×5 mm) was provided and in an evaporation apparatus, magnesium and silver (10:1) were co-deposited to 250 nm and then silver was deposited to 300 nm (1.0×10⁻³ to 1.3×10⁻³ Pa).

The luminescence properties were measured in the same manner as in Example 4. As a result, luminescence was observed from 5 V, and a current density of 1,000 mA/cm² and a green emission of 390 cd/m² were exhibited at 9 V. The maximum emission wavelength λmax was present in 500 nm. The relative luminance after aging was 87.

### EXAMPLE 28

A light-emitting device of ITO/PPV (100 nm)/Compound III-6 (10 nm)/Mg—Ag was fabricated in the same manner as in Example 27.

The luminescence properties were measured in the same manner as in Example 27. As a result, a current density of 380 mA/cm² and an emission of 357 cd/m² were exhibited at 16 V. The maximum emission wavelength λmax was present in 500 nm. The relative luminance after aging was 77.

### EXAMPLE 29

On a washed ITO substrate, Baytron P (PEDOT-PSS solution (polyethylenedioxythiophene-polystyrene sulfonic acid doped product, produced by Bayer) was spin-coated at 2,000 rpm within 60 seconds and then vacuum-dried at 100° C. for 1 hour to form a hole-transporting film (film thickness: about 100 nm). On this film, a solution obtained by dissolving 20 mg of poly(2,7-(9,9-dioctylfluorene)) in 2 ml of chloroform was spin-coated (1,000 rpm, 20 seconds) (film thickness: about 70 nm) and further thereon, a solution obtained by dissolving 20 mg of the polymer of Compound III-4 in 2 ml of methanol was spin-coated (5,000 rpm, 20 seconds) (film thickness: about 10 nm). Subsequently, on this organic thin film, a mask subjected to a patterning (to have a luminescence area of 5 mm×5 mm) was provided and in an evaporation apparatus, aluminum was deposited to 400 nm, thereby fabricating a light-emitting device.

The luminescence properties were measured in the same manner as in Example 27. As a result, a current density of 825 mA/cm² and a blue emission of 670 cd/m² were exhibited at 10 V. The maximum emission wavelength λmax was present in 430 nm. The relative luminance after aging was 85.

### EXAMPLE 30

A light-emitting device of ITO/poly(2,7-(9,9-dioctylfluorene)) (100 nm)/Compound III-15 (30 nm)/Al was fabricated in the same manner as in Example 29.

The luminescence properties were measured in the same manner as in Example 27. As a result, a current density of 260 mA/cm² and a blue emission of 826 cd/m² were exhibited at 7 V. The maximum emission wavelength λmax was present in 431 nm. The relative luminance after aging was 91.

### COMPARATIVE EXAMPLE 9

A light-emitting device of ITO/PPV (50 nm)/Mg—Ag was fabricated and measured on the luminescence properties in the same manner as in Example 27. As a result, luminescence was observed from 4 V and when a voltage of 9 V was applied, the current value was 2,025 mA/cm² and only a luminance as low as 120 cd/cm² was exhibited. The maximum emission wavelength λmax was present in 500 nm. The relative luminance after aging was 28.

### COMPARATIVE EXAMPLE 10

A light-emitting device of ITO/PPV (50 nm)/poly(2,5-pyridinediyl) (30 nm)/Mg—Ag was fabricated and measured on the luminescence properties in the same manner as in Example 28. As a result, when a voltage of 8 V was applied, the current value was 25 mA/cm² and only a luminance as low as 135 cd/m² was exhibited. The maximum emission wavelength λmax was present in 540 nm and the emission from PPV was not obtained. The relative luminance after aging was 28.

### COMPARATIVE EXAMPLE 11

A light-emitting device of ITO/poly(2,7-(9,9-dioctylfluorene)) (100 nm)/Comparative Compound 5 (30 nm)/Al was tried to fabricate in the same manner as in Example 29, however, due to low solubility of Comparative Compound 5 in a solvent such as MeOH and acetic acid, the solution had no suitability for coating and a film having a sufficiently large thickness could not be obtained. The film formed by coating this solution having low solubility as it was had rough surface state and failed to form a homogeneous continuous film and in turn, a light-emitting device having a laminate structure could not be fabricated. This device having bad film quality as such was measured on the luminescence properties in the same manner as in Example above but light was not emitted at all.

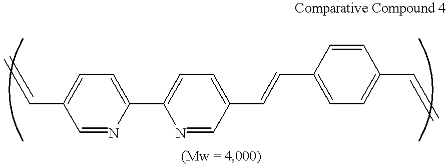

### COMPARATIVE EXAMPLE 12

A light-emitting device of ITO/poly(2,7-(9,9-dioctylfluorene)) (100 nm)/Comparative Compound 6 (30 nm)/Al was tried to fabricate in the same manner as in Example 29, however, Comparative Compound 6 had no solubility in various solvents such as MeOH, chloroform, dimethylformamide and water, and a device having a laminate structure could not be fabricated.

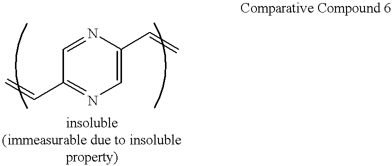

It is seen from these results that in the device using the compound of the present invention the compound not only can function as an electron-transporting material in both the green emission and the blue emission but also the compound itself is useful as the light-emitting material. Furthermore, by making use of difference in the polarity of polymers, a laminate film can be formed only though a coating process. Still further, the minimum driving voltage is low, the emission can have high luminance, and the reduction in the luminance after high-temperature storage is small, revealing excellent durability.

According to the present invention, a polymer having high electron affinity can be provided. Furthermore, an organic light-emitting device capable of high luminance emission and favored with good durability can be obtained only though a coating process of laminating an electron-transporting layer on a low polarity light-emitting polymer while not causing any layer mixing. In particular, even by a coating method in which the luminance obtained is usually low, good luminescence properties can be attained and the device fabricated is advantageous in view of the production cost and the like.

While the invention has been described in detail and with reference to specific embodiments thereof, it will be apparent to one skilled in the art that various changes and modifications can be made therein without departing from the spirit and scope thereof.

What is claimed is:

1. A light-emitting device material which is a polymer comprising at least one partial structure represented by the following formula (I), (II) or (III): 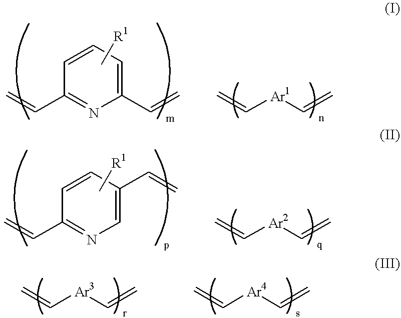
wherein Ar¹ represents a conjugate unsaturated group exclusive of a nitrogen-containing heterocyclic ring having 2 or more nitrogen atoms, m and n each represents a partial ratio by mol in the polymer and satisfies the condition that m+n=100 where n is a numerical value of 0 to less than 100, R¹ represents hydrogen atom or a substituent, provided that when Ar¹ is a substituted fluorene ring or an alkoxy-substituted benzene ring, n is not a value of 50, Ar² represents a conjugate unsaturated group exclusive of a conjugate unsaturated group comprising a benzene ring substituted at two or more positions by an alkyl group having 12 or more carbon atoms, an alkoxy group having 16 or more carbon atoms, an alkoxycarbonyl group having 12 or more carbon atoms or an acyloxy group having 12 or more carbon atoms, and a conjugate unsaturated group comprising a nitrogen-containing heterocyclic ring having a 2,6-pyridinediyl group and 2 or more nitrogen atoms, p and q each represents an arbitrary partial ratio by mol in the polymer but is not a numerical value of 0 or 100, R² represents hydrogen atom or a substituent, Ar³ represents a heteroarylene group having 2 or more nitrogen atoms, Ar⁴ represents a conjugate unsaturated group, and r and s each represents a molar percentage in the polymer and satisfies the condition that r+s=100 where s is a numerical value of 0 to less than 100, provided that when Ar³ is a 2,2′-dipyridyl-4,4′-diyl group or a 2,5-pyrazinediyl group, s is not a value of 0 or 50.

2. The light-emitting device material as claimed in claim 1, wherein in formula (I), Ar¹ is a conjugate unsaturated group exclusive of a nitrogen-containing heterocyclic ring having 2 or more nitrogen atoms, a substituted fluorene ring and an alkoxy-substituted benzene ring.

3. The light-emitting device material as claimed in claim 1, wherein in formula (II), Ar² is a conjugate unsaturated group exclusive of a conjugate unsaturated group comprising a benzene ring substituted by an alkyl group, an alkoxy group, an alkoxycarbonyl group or an acyloxy group, and a conjugate unsaturated group comprising a nitrogen-containing heterocyclic ring having a 2,6-pyridinediyl group and 2 or more nitrogen atoms.

4. The light-emitting device material as claimed in claim 1, which is a polymer comprising at least a partial structure represented by formula (I).

5. The light-emitting device material as claimed in claim 4, wherein in formula (I), n is a numerical value of 0 to 30.

6. The light-emitting device material as claimed in claim 4, wherein in formula (I), n is a numerical value of 0 to 30 and Ar¹ is phenylene, biphenylene, fluorene, anthracene, pyrrole, oxazole, pyridine or quinoline.

7. The light-emitting device material as claimed in claim 1, wherein in formula (II), Ar² is phenylene, biphenylene, fluorene, oxazole, 4,6-pyridinediyl, 2,4-pyridinediyl, 2,5-pyridinediyl or carbazole having a total atom number of at most 20.

8. The light-emitting device material as claimed in claim 1, wherein in formula (III), Ar³ is quinoxaline or Ar³ is pyrazine under the conditions that 100>r≧60 and 0<s≦40.

9. A light-emitting device comprising a pair of electrodes having therebetween a light-emitting layer or a plurality of organic compound thin layers containing a light-emitting layer, wherein at least one layer contains at least one polymer comprising at least one partial structure represented by the following formula (I), (II) or (III): 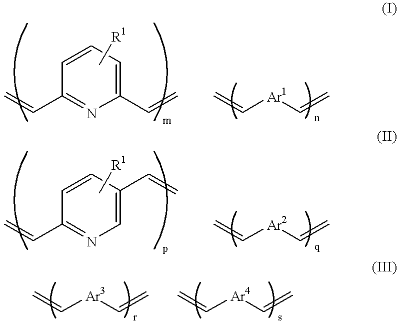
wherein Ar¹ represents a conjugate unsaturated group exclusive of a nitrogen-containing heterocyclic ring having 2 or more nitrogen atoms, m and n each represents a partial ratio by mol in the polymer and satisfies the condition that m+n=100 where n is a numerical value of 0 to less than 100, R¹ represents hydrogen atom or a substituent, provided that when Ar¹ is a substituted fluorene ring or an alkoxy-substituted benzene ring, n is not a value of 50, Ar² represents a conjugate unsaturated group exclusive of a conjugate unsaturated group comprising a benzene ring substituted at two or more positions by an alkyl group having 12 or more carbon atoms, an alkoxy group having 16 or more carbon atoms, an alkoxycarbonyl group having 12 or more carbon atoms or an acyloxy group having 12 or more carbon atoms, and a conjugate unsaturated group comprising a nitrogen-containing heterocyclic ring having a 2,6-pyridinediyl group and 2 or more nitrogen atoms, p and q each represents an arbitrary partial ratio by mol in the polymer but is not a numerical value of 0 or 100, R² represents hydrogen atom or a substituent, Ar³ represents a heteroarylene group having 2 or more nitrogen atoms, Ar⁴ represents a conjugate unsaturated group, and r and s each represents a molar percentage in the polymer and satisfies the condition that r+s=100 where s is a numerical value of 0 to less than 100, provided that when Ar³ is a 2,2′-dipyridyl-4,4′-diyl group or a 2,5-pyrazinediyl group, s is not a value of 0 or 50.

10. A light-emitting device as claimed in claim 9, wherein the layer which contains the polymer is a layer formed by coating at least the polymer.

11. A light-emitting device as claimed in claim 9, wherein in formula (I) , Ar¹ is a conjugate unsaturated group exclusive of a nitrogen-containing heterocyclic ring having 2 or more nitrogen atoms, a substituted fluorene ring and an alkoxy-substituted benzene ring.

12. A light-emitting device as claimed in claim 9, wherein in formula (II), Ar² is a conjugate unsaturated group exclusive of a conjugate unsaturated group comprising a benzene ring substituted by an alkyl group, an alkoxy group, an alkoxycarbonyl group or an acyloxy group, and a conjugate unsaturated group comprising a nitrogen-containing heterocyclic ring having a 2,6-pyridinediyl group and 2 or more nitrogen atoms.

13. A novel polymer comprising at least one partial structure represented by the following formula (I), (II) or (III): 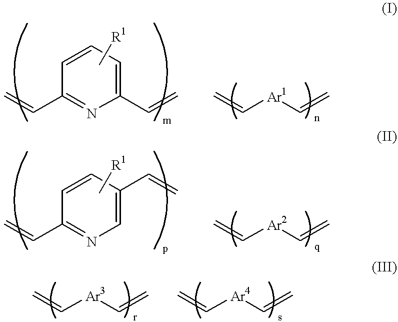
wherein Ar¹ represents a conjugate unsaturated group exclusive of a nitrogen-containing heterocyclic ring having 2 or more nitrogen atoms, m and n each represents a partial ratio by mol in the polymer and satisfies the condition that m+n=100 where n is a numerical value of 0 to less than 100, R¹ represents hydrogen atom or a substituent, provided that when Ar¹ is a substituted fluorene ring or an alkoxy-substituted benzene ring, n is not a value of 50, Ar² represents a conjugate unsaturated group exclusive of a conjugate unsaturated group comprising a benzene ring substituted at two or more positions by an alkyl group having 12 or more carbon atoms, an alkoxy group having 16 or more carbon atoms, an alkoxycarbonyl group having 12 or more carbon atoms or an acyloxy group having 12 or more carbon atoms, and a conjugate unsaturated group comprising a nitrogen-containing heterocyclic ring having a 2,6-pyridinediyl group and 2 or more nitrogen atoms, p and q each represents an arbitrary partial ratio by mol in the polymer but is not a numerical value of 0 or 100, R² represents hydrogen atom or a substituent, Ar³ represents a heteroarylene group having 2 or more nitrogen atoms, Ar⁴ represents a conjugate unsaturated group, and r and s each represents a molar percentage in the polymer and satisfies the condition that r+s=100 where s is a numerical value of 0 to less than 100, provided that when Ar³ is a 2,2′-dipyridyl-4,4′-diyl group or a 2,5-pyrazinediyl group, s is not a value of 0 or 50.

14. The novel polymer as claimed in claim 13, wherein in formula (I), Ar¹ is a conjugate unsaturated group exclusive of a nitrogen-containing heterocyclic ring having 2 or more nitrogen atoms, a substituted fluorene ring and alkoxy-substituted benzene ring.

15. The novel polymer as claimed in claim 13, wherein formula (II), Ar² is a conjugate unsaturated group exclusive of a conjugate unsaturated group comprising a benzene ring substituted by an alkyl group, an alkoxy group, an alkoxycarbonyl group or an acyloxy group, and a conjugate unsaturated group comprising a nitrogen-containing heterocyclic ring having a 2,6-pyridinediyl group and 2 or more nitrogen atoms.
